(19) United States
(12) Patent Application Publication
(10) Pub. No.: US 2006/0116088 A1
(43) Pub. Date: Jun. 1, 2006

(54) Circuit arrangement for a mobile telephone

(76) Inventors: Christian Block, Stainz (AT); Torsten Keiler, Deutschlandsberg (AT)

Correspondence Address: FISH & RICHARDSON PC, P.O. BOX 1022, MINNEAPOLIS, MN, 55440-1022, US

(21) Appl. No.: 10/519,172

(22) PCT Filed: Jun. 27, 2003
(86) PCT No.: PCT/DE03/02149

§ 371 Date: Jan. 17, 2006

(30) Foreign Application Priority Data
Jun. 28, 2002 (DE) 102 29 153.5

(51) Int. Cl. H01Q 11/12

(52) U.S. Cl. 455/121; 455/127.1; 455/78

(57) ABSTRACT

A circuit arrangement for use with a mobile telephone includes a transmitting circuit. The transmitting circuit includes a first signal line that corresponds to a first frequency band, a second signal line that corresponds to a second frequency band, a switch that connects an antenna to one of the first and second signal lines, a first amplifier in series with the first signal line, and a second amplifier in series with the second signal line. A first band-pass filter is between the first amplifier and the switch. The first band-pass filter has a frequency range that corresponds to the first frequency band. A second band-pass filter is between the second amplifier and the switch. The second band-pass filter has a frequency range that corresponds to the second frequency band.

The invention relates to circuit arrangement for a mobile telephone with an antenna, an antenna line and signal lines. In addition, the circuit arrangement contains band-pass filters and amplifiers.

Circuit arrangements of the type noted above are known and are used for the transmission branch of a mobile telephone. The frequency range used in the transmission branch forms the so-called full band. Such a full band can range, for example, from 1.85 to 1.91 GHz. The full band is divided into two half-bands, the lower half-band ranging from 1.85 to 1.88 and the upper half-band from 1.88 to 1.91 GHz. To use the two half-bands, two signal lines are provided in the transmission branch. Signals processed in the two signal lines by OFW filters, for example, reach an amplifier shared by the two signal lines through a reversing switch that switches between the two signal lines. From there, they are fed to a band-pass filter that separates the amplifier from an antenna connected downstream from the band-pass filter outside the frequency band used for transmission, using a type of locking attenuation.

A drawback of the known circuit arrangement is that both half-bands of the transmission branch proceed to the antenna through the same band-pass filter. However, the band-pass filters that are typically used have an attenuation curve that is not optimal across the entire full band. Instead, the characteristic in the upper range of the full band gradually merges into the flank, leading to an increase in the insertion attenuation of up to 3.5 dB at the upper edge of the full band. Accordingly, this results in the disadvantage that the high attenuation at the edge of the full band must be offset by an amplifier provided with a correspondingly higher level of power. Such an amplifier is associated with elevated power consumption, which normally reduces the operating time of mobile telephones operated by batteries in a disadvantageous manner.

It is the goal of the present invention to provide a circuit arrangement in which the power consumption in the transmission branch is reduced.

This goal is achieved, according to the invention, by means of a circuit arrangement according to claim 1. Advantageous further developments of the invention are found in the additional claims.

The invention relates to a circuit arrangement for a mobile telephone having a transmission branch. A first signal line for a first frequency band and at least one other signal line for at least one other frequency are provided in the transmission branch. In addition, an antenna line is provided that is connected to an antenna. The antenna is connected to a switch for optional contact of the antenna to one of the signal lines. An amplifier is connected in series with each signal line. A band-pass filter for the corresponding frequency band is connected between each amplifier and the switch.

The circuit arrangement has the advantage that, for each signal line, there is a dedicated band-pass filter that can be optimized with respect to attenuation on this band, which means that very little loss occurs in the band-pass filter. It is preferable that the corresponding reception band, in each instance, be located correspondingly at a greater distance on the frequency band. This in turn means that the amplifier can be designed to be relatively weak, which results in a reduction in the power consumption of the amplifier and, at the same time, an advantageous increase in the operating time of the mobile telephone.

In addition, a reception branch that contains an additional signal line for an additional frequency band is provided in one embodiment of the circuit arrangement. A band-pass filter for the additional frequency band is connected in a series to the signal line. The reception branch and the transmission branch of the circuit arrangement can be connected to the antenna line by means of a insulator.

It is advantageous if the band-pass filters of the circuit arrangement are designed as ceramic filters. Such ceramic filters are realized, for example, as ceramic bodies provided with holes. The filter function is achieved with coupled, short circuit lines shielded by an external metal coating. However, the band-pass filters can also be designed in the form of OFW filters.

To design the circuit arrangement in a compact manner, it is advantageous to connect several ceramic filters using a shared piece of sheet metal, the sheet metal being located above the ceramic filters. The shared piece of sheet metal can also serve as a shared connection for grounding.

Furthermore, it is advantageous to connect passive components for adjustment of the impedances between the switch and the band-pass filters in each signal line. Such passive components can, for example, be n-filters or a cable. The losses of the circuit arrangement can be reduced further by means of such passive components for impedance adjustment. Furthermore, depending on the filter characteristics, it can be advantageous if a passive component for impedance adjustment is connected between the insulator and the band-pass filter in the reception branch.

To reduce the space requirements of the circuit arrangement, as well as to design the circuit arrangement in a compact manner, it is advantageous if the insulator and the passive components are integrated into a multilayer substrate. In addition, the switch can be mounted on the upper side of the multilayer substrate. Such multilayer substrates are known, for example, under the name “LTCC module=Low Temperature Cofired Ceramic module.” Such LTCC modules can be manufactured to be space saving and contain a plurality of various passive components and active components.

To effectively reduce the energy consumption of the amplifier, it is advantageous if the amplification Pₒᵤₜ/Pᵢₙ of the amplifiers of the circuit arrangement is less than 26 dB.

It is also advantageous if the band-pass filters are specifically matched to the corresponding frequency range. This can be achieved, for example, by using the filter curve of a band-pass filter, which is essentially suitable for filtering the full band but already has a high attenuation at the high-frequency end of the full band, as the basis for the band-pass filters in the circuit arrangement. As an example, the band-pass filter for the full band can also be used for the lower half-band. By shifting the attenuation curve of the band-pass filter, which is easily achieved by shortening the component (ceramic body) as well as by subsequent optimization, the attenuation curve can be matched to the upper half-band. This results in minimal attenuation occurring in the band passes for both half-bands.

As a result of the use of identical attenuation curves that can only be brought into approximate alignment by shifting them along the frequency curves, it is not necessary to develop a new band-pass filter to bring about the circuit arrangement. Instead, a known band-pass filter that is essentially suitable for filtering the full band can be used in an advantageous manner.

In the following, the invention is explained in greater detail on the basis of exemplary embodiments and the corresponding figures.

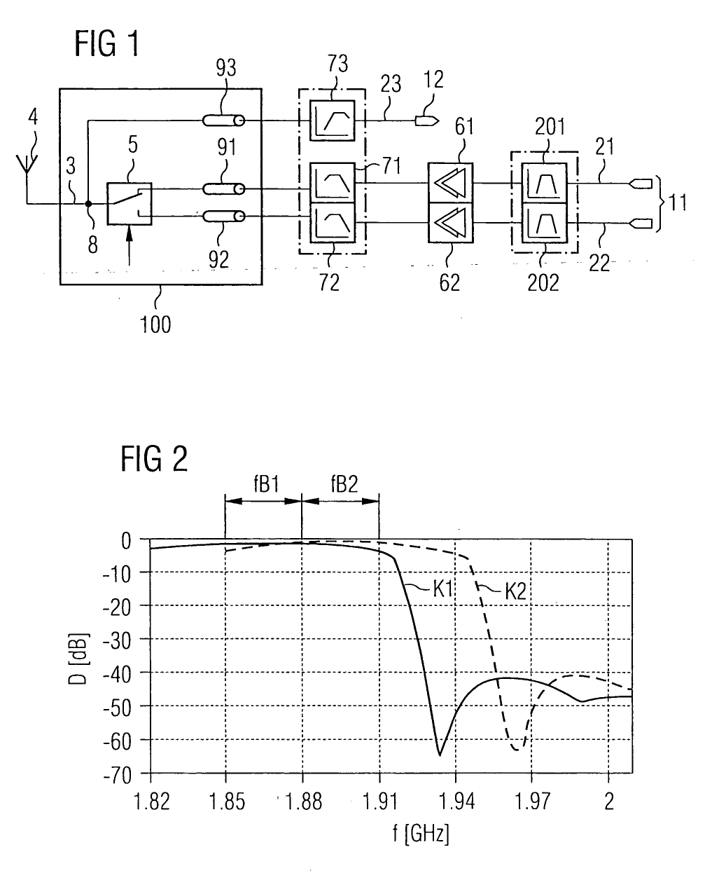

FIG. 1 shows a circuit arrangement in a schematic depiction.

FIG. 2 shows attenuation curves of band-pass filters, such as those that can be used in the circuit arrangement depicted in FIG. 1.

FIG. 1 shows a circuit arrangement for a mobile telephone. A transmission branch 11 and a reception branch 12 are provided. The reception branch 12 leads to a low-noise amplifier. The reception branch 12 (not shown in FIG. 1) is connected to a chip set, which modulates the wanted signals and upwardly mixes them into the respective frequency range of the transmission branch. The transmission branch 11 comprises two signal lines 21, 22, whereas the reception branch 12 comprises only one signal line 23. The signals coming from a chip set and running through the signal lines 21, 22 are processed in surface wave filters 201, 202. Each signal subsequently reaches an amplifier 61, 62 that amplifies the voice signals in such a way that they are suitable for transmission of the signals. To separate the amplifiers 61, 62 from the antenna 4 of the circuit arrangement, band-pass filters 71, 72 are provided, each of which is separately adjusted for a signal line 21, 22. The insertion attenuation of the band-pass filters 71, 72 can be advantageously reduced in that for each signal line 21, 22 that is operated on a corresponding half-band, there is a dedicated amplifier 61, 62 as well as a dedicated band-pass filter 71, 72, so that the amplifiers 61, 62 can be designed for lower output. As a result, both the energy consumption of the circuit arrangement and the space requirements are reduced. Amplifiers 61, 62 designed for lower output require less space than an amplifier designed for higher output. The transmission branch 11 is also connected to an LTCC module 100 that is, with a multilayer substrate with a switch 5, for example, integrated into its upper side. Integrated into the multilayer substrate is a switch 5, which connects the antenna line connected to the antenna 4 with either the signal line 21 or the signal line 22. Passive components 91, 92, which are integrated into the module 100, are provided for adjustment of the impedances between the switch 5 and the band-pass filters 71, 72. These passive components 91, 92 can be, for example, n-filters or a cable. The switch 5 can be a GaAs field effect transistor, for example. However, it can also consist of PIN diodes. Furthermore, it is also possible to build the switch 5 with micromechanics components, which, for the system envisioned here, would offer the very important advantage of good linearity and the advantage of reduced losses.

In addition, an insulator 8 can be provided, which can be integrated into the module 100 through the use of ferrite materials. The purpose of the insulator 8 is to separate the transmission branch 11 from the reception branch 12. A band-pass filter 73, in turn, is connected in the signal line 23 of the reception branch 12 and is connected to the insulator 8 through a passive component 93. The position of the insulator is variable and is not limited to the depiction in FIG. 1. In a variant of the invention, the insulator can also be disposed outside the multilayer module 100.

It can also be provided that a duplexer is integrated into the multilayer module 100, said duplexer—as seen from the antenna—causing a split into the frequency range of the transmission branch and a frequency range at a lower position. This means that the antenna line constitutes a connection to the duplexer within the multilayer module.

The frequency band used in the transmission branch 11, which is also referred to as a full band, can range, for example, from 1.85 to 1.91 GHz. This full band is divided into two half-bands. In this arrangement, the first half-band is the frequency range fB1, which is shown in FIG. 2 and ranges from 1.85 GHz to 1.88 GHz. A band-pass filter having the filter curve identified by K1 in FIG. 2 can be used for the first frequency range fB1, which is linked to the signal line 21. The filter curve K1 is characterized by a very low attenuation in the frequency range fB1. If the filter in FIG. 2 characterized by the filter curve K1 were used for band-pass filtering in the full band, an already significant attenuation of about 3.5 dB at the right band edge at 1.91 GHz would exist for the second half-band, which encompasses the frequency range fB2, which, in turn, according to FIG. 2, ranges from 1.88 to 1.91 GHz. Accordingly, it is advantageous, according to FIG. 2, to provide the filter 72 with the filter curve K2, which is shifted to the right along the frequency axis by 0.03 GHz relative to the filter curve K1.

FIG. 2 shows filter curves, in which the amplification D of the filter, measured in dB, is plotted against the frequency, measured in GHz.

### LIST OF REFERENCE NUMBERS

11 Transmission branch
12 Reception branch
21, 22, 23 Signal line
3 Antenna line
4 Antenna
5 Switch
61, 62, 63 Amplifier
71, 72, 73 Band-pass filter
8 Insulator
91, 92, 93 Passive component
100 Multilayer module
201, 202 OFW filter
K1, K2 Attenuation curve
fB1, fB2 Frequency range
f Frequency
D Amplification

1. A circuit arrangement for use with a mobile telephone, the circuit arrangement comprising a transmitting circuit, the transmitting circuit comprising:
a first signal line that corresponds to a first frequency band;
a second signal line that corresponds to a second other frequency band;
a switch that connects an antenna to one of the first and second signal lines;
a first amplifier in series with the first signal line;
a second amplifier in series with the second signal line;
a first band-pass filter between the first amplifier and the switch, the first band-pass filter having a frequency range that corresponds to the first frequency band; and
a second band-pass filter between the second amplifier and the switch, the second band-pass filter having a frequency range that corresponds to the second frequency band.

2. The circuit arrangement of claim 1, further comprising a receiving circuit the receiving circuit comprising:
a third signal line that corresponds to a third frequency band; and
a third band-pass filter in series with the third signal line,
wherein the circuit arrangement further comprises an insulator between the transmitting circuit and the receiving circuit.

3. The circuit arrangement of claim 1, wherein the first and second band-pass filters comprise ceramic filters.

4. The circuit arrangement of claim 3, further comprising sheet metal on which the first and second band-pass filters are mounted.

5. The circuit arrangement of claim 1, further comprising passive components between the switch and the first and second band-pass filters, the passive components for adjusting impedance.

6. The circuit arrangement of claim 2, further comprising a passive component between the insulator and the third band-pass filter, the passive component for adjusting impedance.

7. The circuit arrangement of claim 2, wherein the insulator, the switch and passive components comprise parts of a multilayer module.

8. The circuit arrangement of claim 1, wherein the first and second band-pass filters have attenuation curves that can be brought into approximate alignment by shifting along a frequency axis.

9. The circuit arrangement of claim 1, wherein the first and second amplifiers is have amplifications of less than 26 dB.

10. Circuitry comprising:
a transmitting portion; and
a receiving portion;
wherein the transmitting portion comprises plural signal lines, each of the plural signal lines for transmitting a signal in a different frequency band, each of the plural signal lines comprising, in order, a switch for connecting an antenna to a signal line, a passive component, a band-pass filter, an amplifier, and a surface wave filter; and
wherein the transmitting portion comprises a signal line for receiving a signal from an external source, the signal line comprising a passive component, and a band-pass filter.

11. The circuitry of claim 10, further comprising an insulator between the transmitting portion and the receiving portion.

12. The circuitry of claim 10, wherein passive components in the transmitting portion adjust an impedance between the switch and band-pass filters in the transmitting portion.

13. The circuitry of claim 10, wherein the switch, and passive components of the transmitting portion and the receiving portion comprise part of a multilayer module.

14. The circuitry of claim 10, wherein the switch comprises at least one of a field effect transistor, diodes, and mechanical components.
